(19) United States
(12) Patent Application Publication
(10) Pub. No.: US 2004/0191433 A1
(43) Pub. Date: Sep. 30, 2004

(54) Ink-jet recording material

(76) Inventors: Hiroshi Sakaguchi, Tokyo (JP); Yukihiro Suzuki, Tokyo (JP)

Correspondence Address: BIRCH STEWART KOLASCH & BIRCH, PO BOX 747, FALLS CHURCH, VA, 22040-0747, US

(21) Appl. No.: 10/808,454

(22) Filed: Mar. 25, 2004

(30) Foreign Application Priority Data
Mar. 28, 2003 (JP) 2003-089519

(51) Int. Cl. B41M 5/00

(52) U.S. Cl. 428/32.34

(57) ABSTRACT

There is disclosed an comprising a support, and at least one porous ink-receptive layer containing inorganic fine particles and polyvinyl alcohol provided as a main component of a binder on the support, wherein at least one of said ink-receptive layers contains a polymer emulsion containing a polymer compound which shows a hydrophilic property at a temperature region of a predetermined temperature, which is a thermosensitive temperature, or less and shows a hydrophobic property at a temperature region higher than the thermosensitive temperature in an amount of 1 to 25% by weight based on the amount of the polyvinyl alcohol in terms of a solid content.

### BACKGROUND OF THE INVENTION

1. Field of the Invention

The present invention relates to an ink-jet recording material, more specifically to an ink-jet recording material that has photo-like high glossiness, is excellent in ink-absorption property, and has high productivity.

2. Prior Art

As a recording material to be used for an ink-jet recording system, a recording material which comprises a porous ink-receptive layer comprising a pigment such as amorphous silica, and a water-soluble binder such as polyvinyl alcohol being provided on a support which is the so-called ink-jet recording sheet has generally been known.

In recent years, as a recording material having photo-like glossiness, it has been proposed to use ultrafine particles such as amorphous silica or wet process silica ground or pulverized to several hundred nm or so as inorganic fine particles of an ink-receptive layer. For example, in Japanese Patent Publication No. 56552/1991, Japanese Provisional Patent Publications No. 119423/1998, No. 2000-211235 and No. 2000-309157, there have been disclosed to use silica prepared by a gas phase process (hereinafter referred to as “fumed silica”), in Japanese Provisional Patent Publications No. 286165/1997 and No. 181190/1998, there have been disclosed to use pulverized silica prepared by a precipitation process, and in Japanese Provisional Patent Publication No. 2001-277712, there has been disclosed to use pulverized silica prepared by a gel process. However, improvement of characteristics in an ink-jet printer is remarkable, printing rate is also abruptly improved in addition to finer printing image, and higher ink-absorption property has been desired.

On the other hand, to obtain an ink-jet recording material having photo-like high glossiness and high ink-absorption property, it has been disclosed a method that a drying step after providing a coating solution on a support is carried out under relatively mild conditions. For example, in Japanese Provisional Patent Publication No. 91238/1999, there has been disclosed a method that drying is carried out without blowing wind, and in Japanese Provisional Patent Publications No. 2001-10207 and No. 2001-96900, there have been disclosed a method that drying is carried out at a relatively low temperature. However, in these methods, a long time is required for the drying step so that there is a problem that productivity cannot be heightened. In International Patent Application WO 02/85634 (pages 3 to 6) and Japanese Provisional Patent Publication No. 2003-40916 (pages 3 and 4), there have been disclosed a method for preparing an ink-jet recording material having high productivity as well as good glossiness and ink-absorption property by using inorganic particles such as silica, etc., and a thermosensitive polymer latex as a binder, and after providing a coating solution on a support, the coated material is cooled to lower than the thermosensitive temperature of the thermosensitive polymer latex to thicken and gel the coated solution and the material is dried while maintaining the above situation. However, the coating solution containing the thermosensitive polymer latex and the silica fine particles irreversibly thicken and gel at a temperature of the thermosensitive temperature or lower, and the once gelled coating solution does not return to a fluid state even when it is heated again. Thus, if the temperature of the coating solution is lowered in a piping at a temperature lower than the thermosensitive temperature with a certain reason, the piping is clogged and a measure becomes difficult whereby problems remain in the production process.

### SUMMARY OF THE INVENTION

An object of the present invention is to provide an ink-jet recording material having photo-like high glossiness, high ink-absorption property and high productivity.

The above objects of the present invention can be accomplished by an ink-jet recording material comprising a support, and at least one porous ink-receptive layer containing inorganic fine particles and polyvinyl alcohol provided as a main component of a binder on the support, wherein at least one of said ink-receptive layers contains a polymer emulsion containing a polymer compound which shows a hydrophilic property at a temperature region of a predetermined temperature (a thermosensitive point) or less and shows a hydrophobic property at a temperature region higher than the thermosensitive point in an amount of 1 to 25% by weight based on the amount of the polyvinyl alcohol in terms of a solid content.

### DESCRIPTION OF THE PREFERRED EMBODIMENTS

In the following, the present invention will be explained in detail. As the inorganic fine particles to be used in the ink-receptive layer of the present invention, there may be mentioned various kinds of conventionally known fine particles such as silica, alumina, alumina hydrate, calcium carbonate, magnesium carbonate, titanium dioxide, etc., and silica fine particles are preferred in the points of ink-absorption property and productivity. It is particularly preferred to use a wet process silica or a fumed silica each finely pulverized.

In synthesized silica, they can be roughly classified into wet process silica, fumed silica, and others according to the preparation processes. The wet process silica can be further classified into a precipitation method silica, a gel method silica and a sol method silica according to the preparation processes. The precipitated silica can be prepared by reacting sodium silicate and sulfuric acid under alkali conditions, silica particles grown in particle size aggregated and precipitated, and then, they are processed through filtration, washing, drying, pulverization and classification to obtain a product. As the precipitated silica, it is commercially available from TOSOH SILICA CORPORATION (Japan) under trade name of Nipsil, K.K. Tokuyama (Japan) under trade name of Tokusil. The gel method silica can be produced by reacting sodium silicate and sulfuric acid under acidic conditions. In this method, small silica particles are dissolved during ripening and so reprecipitated between primary particles which are larger sized particles that primary particles are combined to each other. Thus, clear primary particles disappear and form relatively hard agglomerated particles having inner void structure. For example, it is commercially available from TOSOH SILICA CORPORATION (Japan) under trade name of Nipgel, Grace Japan Co., Ltd. (Japan) under trade names of Syloid, Sylojet, and the like. The sol method silica is also called to as colloidal silica and can be obtained by heating and ripening silica sol obtained by methathesis of sodium silicate by an acid such as sodium silicate, or passing through an ion-exchange resin layer, and is commercially available from Nissan Chemical Industries, Ltd. (Japan) under trade name of SNOWTEX.

Fumed silica is also called to as the drying method silica relative to the wet process method, and it can be generally prepared by a flame hydrolysis method. More specifically, it has generally been known a method in which silicon tetrachloride is burned with hydrogen and oxygen, and a silane such as methyl trichlorosilane or trichlorosilane may be used in place of silicon tetrachloride singly or as a mixture in combination with silicon tetrachloride. The fumed silica is commercially available from Nippon Aerosil K.K. (Japan) under the trade name of Aerosil, and K.K. Tokuyama (Japan) under the trade name of QS type, etc.

In the present invention, a wet process silica pulverized to an average secondary particle size of 400 nm or less is particularly preferably used. The wet process silica to be used in the present invention is silica particles preferably having an average primary particle size of 50 nm or less, more preferably 3 to 40 nm, and an average secondary particle size of 1 pm or more, more preferably 5 to 50 μm, and further preferably wet process silica particles finely pulverized to an average secondary particle size of 400 nm or less in the presence of a cationic compound. Precipitation method silica particles are particularly preferred. Incidentally, the average primary and secondary particle sizes mentioned in the present specification are based on the conventionally known method observed by an electron microscope (Scanning type electron microscope and Transmittance type electron microscope).

Since the wet process silica produced by the conventional method has an average secondary particle size of 1 μm or more, this is used after finely pulverized. As the pulverization method, a wet pulverization method in which silica dispersed in an aqueous medium is mechanically pulverized is preferably used. At this time, it is particularly preferred to use a precipitation method silica having an oil absorption amount of 210 ml/100 g or more and an average secondary particle size of 5 μm or more since increase in initial viscosity of the dispersion is controlled, high concentration dispersion is realized and the particles can be pulverized finer due to increase in pulverization and dispersion efficiencies. By using a higher concentration dispersion, productivity of the recording paper is also improved. The oil absorption amount can be measured according to the description of JIS K-5101.

As a specific method to obtain wet process silica fine particles having an average secondary particle size of 400 nm or less of the present invention, there may be mentioned, for example, a method of mixing silica particles and a cationic compound in water (addition may be carried out either of which firstly or may be simultaneously carried out), a method of mixing each of dispersions or aqueous solutions, and then, mixing the liquid by using at least one of a saw blade type dispersing device, a propeller blade type dispersing device, and a rotor stator type dispersing device to obtain a provisional dispersion. If necessary, a suitable amount of a low boiling point solvent, etc., may be further added to the dispersion. An amount of the cationic compound is preferably 0.5 to 20% by weight, more preferably 1 to 10% by weight based on the amount of the silica particles. By using the compound within the range as specified above, a viscosity of the silica provisional dispersion is not so high and a solid concentration can be heightened. The solid concentration of the silica provisional dispersion of the present invention is preferably high, but it is too high, dispersion becomes impossible so that it is preferably in the range of 15 to 40% by weight, more preferably 20 to 35% by weight.

Next, the silica provisional dispersion obtained by the above-mentioned method is further dispersed by using a more potent mechanical means to obtain a wet process silica fine particle dispersion having an average secondary particle size of 400 nm or less. As the mechanical means, those conventionally known in the art can be employed, and there may be used, for example, a media mill such as a ball mill, a beads mill, a sand grinder, etc., a pressure type dispersing device such as a high-pressure homogenizer, an ultra high-pressure homogenizer, etc., an ultrasonic wave dispersing device, and a thin-film spin type dispersing device, etc.

In the present invention, fumed silica is also preferably used. An average particle size of a primary particle of the fumed silica to be used in the present invention is preferably 30 nm or less, and more preferably 15 nm or less to obtain higher glossiness. More preferred are those having an average particle size of the primary particles of 3 to 15 nm, particularly preferably 3 to 10 nm, and having a specific surface area measured by the BET method of 200 m²/g or more, more preferably 250 to 500 m²/g. The BET method mentioned in the present invention means one of a method for measuring a surface area of powder material by a gas phase adsorption method and is a method of obtaining a total surface area possessed by 1 g of a sample, i.e., a specific surface area, from an adsorption isotherm. In general, as an adsorption gas, a nitrogen gas has frequently been used, and a method of measuring an adsorption amount obtained by the change in pressure or a volume of a gas to be adsorbed has most frequently been used. Most famous equation for representing isotherm of polymolecular adsorption is a Brunauer-Emmett-Teller equation which is also called to as a BET equation and has widely been used for determining a surface area of a substance to be examined. A surface area can be obtained by measuring an adsorption amount based on the BET equation and multiplying the amount with a surface area occupied by the surface of one adsorbed molecule.

In the ink-receptive layer of the present invention, fumed silica dispersed to an average aggregation particle size of 300 nm or less in the presence of a cationic compound is preferably used. As the dispersing method, fumed silica and a dispersing medium are provisionally mixed by a usual propeller stirring, turbine type stirring, homomixer type stirring, etc., and then, dispersion is preferably carried out by using a media mill such as a ball mill, a beads mill, a sand grinder, etc., a pressure type dispersing device such as a high-pressure homogenizer, an ultra high-pressure homogenizer, etc., an ultrasonic wave dispersing device, and a thin-film spin type dispersing device, etc.

As the cationic compound to be used for silica dispersion, a cationic polymer or a water-soluble metallic compound may be used. As the cationic polymer, there may be preferably mentioned polyethyleneimine, polydiallylamine, polyallylamine, polyalkylamine, as well as polymers having a primary to tertiary amino group or a quaternary ammonium group as disclosed in Japanese Provisional Patent Publications No. 20696/1984, No. 33176/1984, No. 33177/1984, No. 155088/1984, No. 11389/1985, No. 49990/1985, No. 83882/1985, No. 109894/1985, No. 198493/1987, No. 49478/1988, No. 115780/1988, No. 280681/1988, No. 40371/1989, No. 234268/1994, No. 125411/1995 and No. 193776/1998, etc. In particular, a diallylamine derivative is preferably used as the cationic polymer. An average molecular weight (Mw; weight average molecular weight) of these cationic polymers is preferably 2,000 to 100,000, particularly preferably in the range of 2,000 to 30,000 in the points of dispersibility and a viscosity of the dispersion.

As the water-soluble metallic compound, there may be mentioned, for example, a water-soluble polyvalent metallic salt. As such a salt, there may be mentioned a water-soluble salt of a metal selected from the group consisting of calcium, barium, manganese, copper, cobalt, nickel, aluminum, iron, zinc, titanium, zirconium, chromium, magnesium, tungsten, and molybdenum. More specifically, such a water-soluble metallic compound may include, for example, calcium acetate, calcium chloride, calcium formate, calcium sulfate, barium acetate, barium sulfate, barium phosphate, manganese chloride, manganese acetate, manganese formate dihydrate, ammonium manganese sulfate hexahydrate, cupric chloride, copper (II) ammonium chloride dihydrate, copper sulfate, cobalt chloride, cobalt thiocyanate, cobalt sulfate, nickel sulfate hexahydrate, nickel chloride hexahydrate, nickel acetate tetrahydrate, ammonium nickel sulfate hexahydrate, amide nickel sulfate tetrahydrate, aluminum sulfate, aluminum sulfite, aluminum thiosulfate, poly(aluminum chloride), aluminum nitrate nonahydrate, aluminum chloride hexahydrate, ferrous bromide, ferrous chloride, ferric chloride, ferrous sulfate, ferric sulfate, zinc bromide, zinc chloride, zinc nitrate hexahydrate, zinc sulfate, zinc p-phenolsulfonate, titanium chloride, titanium sulfate, titanium lactate, zirconium acetate, zirconium chloride, zirconium oxychloride octahydrate, zirconium hydroxychloride, chromium acetate, chromium sulfate, magnesium sulfate, magnesium chloride hexahydrate, magnesium citrate nonahydrate, sodium phosphorus wolframate, tungsten sodium citrate, dodecawolframatophosphate n hydrate, dodecawolframatosilicate 26 hydrate, molybdenum chloride, dodecamolybdatephosphate n hydrate, etc.

Of these water-soluble polyvalent metallic compounds as mentioned above, a compound comprising aluminum or a metal of Group 4A (Group 4) of the Periodic Table (for example, zirconium, titanium) is preferably used. A water-soluble aluminum compound is particularly preferably used. The water-soluble aluminum compound may include, for example, aluminum chloride and its hydrate, aluminum sulfate and its hydrate, aluminum alum, etc. as an inorganic salt thereof. Moreover, it has been known a basic poly(aluminum hydroxide) compound which is an inorganic aluminum-containing cationic polymer, and it is preferably used.

The above-mentioned poly(aluminum-hydroxide) compound is a water-soluble poly(aluminum hydroxide) a main component of which is represented by the following formula (1), (2) or (3), and which contains a polynuclear condensed ion which is basic and a polymer in a stable form, such as

[Al₆(OH)₁₅]³⁺, [Al₈(OH)₂₀]⁴⁺, [Al₁₃(OH)₃₄]⁵⁺, [Al₂₁(OH)₆₀]³⁺, etc.

[Al₂(OH)ₙCl₆₋ₙ]ₘ (1)

[Al(OH)₃]ₙAlCl₃ (2)

Alₙ(OH)ₘCl₍₃ₙ₋ₘ₎0<m<3n (3)

These water-soluble aluminum compounds are commercially available from Taki Chemical, K.K. (Japan) under the trade name of poly(aluminum chloride) (PAC, trade name) as a water treatment agent, from Asada Chemical K.K. (Japan) under the trade name of poly(aluminum hydroxide) (Paho, trade name), from K.K. Riken Green (Japan) under the trade name of Pyurakemu WT (trade name) and other manufacturers with the same objects whereby various kinds of different grades can be easily obtained.

The water-soluble compound containing an element of Group 4 of the Periodic Table to be used in the present invention is more preferably a water-soluble compound containing titanium or zirconium. As the water-soluble compound containing titanium, there may be mentioned titanium chloride and titanium sulfate, and as the water-soluble compound containing zirconium, there may be mentioned zirconium acetate, zirconium chloride, zirconium oxychloride, zirconium hydroxychloride, zirconium nitrate, basic zirconium carbonate, zirconium hydroxide, zirconium lactate, ammonium zirconium carbonate, potassium zirconium carbonate, zirconium sulfate, zirconium fluoride, and the like. In the present invention, the term “water-soluble” means that the compound is dissolved in water in an amount of 1% by weight or more at normal temperature under normal pressure.

In the present invention, polyvinyl alcohol is used as a main component of a binder for the inorganic particles. Polyvinyl alcohol is excellent in an ability as a binder for inorganic fine particles as well as excellent in transparency and relatively low swellability at around room temperature, so that there are characteristics that inhibition of ink-absorption by swelling is little, or the like. When the polyvinyl alcohol is used as a main component of the binder, and the thermosensitive polymer latex is used in combination, a coating solution shows sufficient increase in viscosity when it is placed at a low temperature. Also, a phenomenon of irreversible gelation which is considered to be generated by an interaction between the thermosensitive polymer latex and inorganic fine particles when the thermosensitive polymer latex is used as a main component of the binder does not occur so that handling of the coating solution is easy.

Among the polyvinyl alcohols, preferred is a completely or partially saponified polyvinyl alcohol or a cationically-modified polyvinyl alcohol. Particularly preferred is a partially or completely saponified polyvinyl alcohol having a saponification degree of 80% or more. Those having an average polymerization degree of 200 to 5000 are preferred.

As the cationically-modified polyvinyl alcohol, there may be mentioned, for example, a polyvinyl alcohol having a primary to tertiary amino groups or a quaternary ammonium group at the main chain or side chain of the polyvinyl alcohol as disclosed in Japanese Provisional Patent Publication No. 10483/1986.

An amount of the polyvinyl alcohol is preferably as little as possible since a void volume in the ink-receptive layer is large and ink-absorption ability is high, but it is too little, the ink-receptive layer is brittle to cause surface defects such as cracking, etc. or glossiness is lowered. Thus, it is preferably in the range of 5 to 40% by weight, particularly preferably 10 to 30% by weight based on an amount of the inorganic fine particles.

In the present invention, it is preferred to use a cross-linking agent (film hardening agent) of the polyvinyl alcohol. Specific examples of the cross-linking agent may include an aldehyde type compound such as formaldehyde and glutaraldehyde; a ketone compound such as diacetyl and cyclopentanedione; a compound having a reactive halogen such as bis(2-chloroethylurea), 2-hydroxy-4,6-dichloro-1,3,5-triazine, and those as disclosed in U.S. Pat. No. 3,288,775; divinylsulfone; a compound having a reactive olefin as disclosed in U.S. Pat. No.3,635,718; a N-methylol compound as disclosed in U.S. Pat. No. 2,732,316; an isocyanate compound as disclosed in U.S. Pat. No. 3,103,437; an aziridine compound as disclosed in U.S. Pat. Nos. 3,017,280 and 2,983,611; a carbodiimide type compound as disclosed in U.S. Pat. No. 3,100,704; an epoxy compound as disclosed in U.S. Pat. No. 3,091,537; a halogen carboxyaldehyde compound such as mucochloric acid, a dioxane derivative such as dihydroxydioxane, an inorganic cross-linking agent such as chromium alum, zirconium sulfate, boric acid, a borate and borax, and they may be used independently or in combination of two or more. Of these, boric acid, borax and a borate are particularly preferred.

Next, the polymer emulsion of the present invention is explained. In the present specification, a property in which hydrophilic property/hydrophobic property are abruptly changed at a certain temperature is called to as a thermosensitive property, and a temperature which is the boarder thereof is called to as a thermosensitive temperature. A polymer compound to be contained in the polymer emulsion of the present invention which shows a hydrophilic property at a certain temperature (the thermosensitive temperature) or less and shows a hydrophobic property at a temperature higher than the thermosensitive temperature is a homopolymer of a monomer which gives a polymer compound showing reversible change between the hydrophilic property/hydrophobic property when it is homopolymerized, or a copolymer thereof with other monomer(s) which copolymer possesses the thermosensitive property. This thermosensitive property can be confirmed by, for example, abrupt change in the viscosity or abrupt change in the solubility of a mixture of the polymer compound and water at the thermosensitive temperature. It is similar in the case of the polymer emulsion, and the thermosensitive property and the thermosensitive temperature can be confirmed by abrupt change in the viscosity or transparency of the polymer emulsion at the thermosensitive temperature.

As the monomer which gives the thermosensitive property when the monomer is homopolymerized, there have been known N-alkyl or N-alkylene(meth)acrylamide derivatives (here “(meth)acryl” means “methacryl and acryl”), vinyl methyl ether, polyethyleneglycol(meth)acrylate derivatives and the like, and they can be optionally used. In the present invention, it is particularly preferred to use the N-alkyl or N-alkylene(meth)acrylamide derivatives.

Examples of the N-alkyl or N-alkylene(meth)acrylamide derivatives may include N-ethyl(meth)acrylamide, N-isopropyl(meth)acrylamide, N-cyclopropyl(meth)acrylamide, N-ethyl(meth)acrylamide, N,N-diethylacrylamide, N,N-dimethyl(meth)acrylamide, N-n-propyl(meth)acrylamide, N-methyl-N-n-propylacrylamide, N-methyl-N-isopropylacrylamide, N-(meth)acryloylpyrrolidine, N-(meth)acryloylpiperidine, N-tetrahydrofurfuryl(meth)acrylamide, N-methoxypropyl(meth)acrylamide, N-ethoxypropyl(meth)acrylamide, N-isopropoxypropyl(meth)acrylamide, N-ethoxyethyl(meth)acrylamide, N-(2,2-dimethoxyethyl)-N-methylacrylamide, N-methoxyethyl(meth)acrylamide, N-(meth)acryloylmorpholine, etc. Of 644 these, N-isopropylacrylamide, N-n-propylacrylamide, N,N-diethylacrylamide, N-acryloylmorpholine are preferred in the points of the thermosensitive property, handling easiness and easy availability.

As the other monomer copolymerizable with the monomer which gives a polymer compound having the thermosensitive property mentioned above, there may be mentioned a lipophilic vinyl compound, a hydrophilic vinyl compound, and an ionic vinyl compound. Examples of the lipophilic vinyl compound may include (meth)acrylates such as methyl (meth)acrylate, n-butyl (meth)acrylate, 2-ethylhexyl (meth)acrylate, etc., styrene, ethylene, vinyl acetate and the like. Examples of the hydrophilic vinyl compound may include (meth)acrylates such as 2-hydroxypropyl (meth)acrylate, etc., acrylamides such as (meth)acrylamide, N-methyl (meth)acrylamide, N-vinyl-2-pyrrolidone, etc., which do not show the thermosensitive property when they are homopolymerized, and examples of the ionic vinyl compound may include carboxylic acid group-containing monomers such as acrylic acid, methacrylic acid, maleic acid, monoethyl maleate, etc., sulfonic acid group-containing monomers such as styrenesulfonic acid, etc., amino group-containing monomers such as N,N-dimethylaminoethyl (meth)acrylate, N,N-dimethylaminopropyl (meth)acrylate, etc., and their quaternary ammonium salts and the like. When the inorganic fine particles of the present invention are inorganic fine particles finely dispersed in the presence of a cationic compound, a polymer emulsion containing a polymer compound to which a monomer having a tertiary amino group and/or quaternary ammonium group is/are copolymerized is particularly preferred.

Also, a monomer having a carbonyl group may be preferably used as a monomer to be copolymerized. In particular, when a polymer emulsion using a monomer containing a carbonyl group and a cross-linking agent having at least two hydrazine groups or semicarbazide groups are added to a coating solution, strength and water-resistance of the resulting ink-receptive layer are heightened so that it is preferred. Specific examples of the monomer having a carbonyl group may include acrolein, diacetone acrylamide, diacetone methacrylate, etc., and as the hydrazine type cross-linking agent, a product obtained by the reaction of adipic hydrazide or a polyisocyanate compound with hydrazine, and other commercially available hydrazine type cross-linking agent may be utilized.

In the polymer emulsion of the present invention, it is possible to control the thermosensitive temperature of the polymer emulsion by selecting a kind and contents of a monomer component which gives the thermosensitive property and a monomer component which does not give the same in the polymer compound. A ratio of the monomer component which does not give the thermosensitive property is preferably 50% by weight or less, more preferably 30% by weight or less in the total monomer component in the point of temperature response.

The thermosensitive temperature of the polymer emulsion according to the present invention is not specifically limited, and it is possible to control in the range of 1 to 100° C., and preferably 5 to 50° C. in the point of operatability, more preferably 5 to 40° C.

As a method for preparing the polymer emulsion of the present invention, a technique of usual emulsion polymerization may be utilized. Since the polymer compound becomes hydrophobic at a temperature higher than the thermosensitive temperature, it is preferred to carry out the polymerization reaction at a temperature higher than the thermosensitive temperature of the polymer compound. As a surfactant to be used for the emulsion polymerization, either of anionic, cationic, nonionic or amphoteric surfactant may be used. When the inorganic fine particles of the present invention are inorganic fine particles finely dispersed in the presence of a cationic compound, a cationic surfactant is particularly preferred. Also, a reactive surfactant is preferably used.

When the polymerization reaction of the polymer emulsion is carried out, the polymerization reaction is preferably carried out in the co-presence of the polyvinyl alcohol or the polyvinyl alcohol derivatives since compatibility of the polymer emulsion with the polyvinyl alcohol is improved.

The polymer emulsion of the present invention may be either an emulsion with a uniform composition or an emulsion in which the compositions may be varied between the center portion and the peripheral portion. It is preferred to use an emulsion having a core/shell structure with different compositions in the points of a viscosity-increasing effect at the time of cooling to a temperature not higher than the thermosensitive temperature and surface glossiness of the coated product. In this case, the polymer having the thermosensitive property is preferably contained at the shell portion.

For the core portion, a conventionally known organic polymer emulsion or inorganic fine particles may be used. A particle size of the core portion is preferably as little as possible in the point of surface glossiness, and those having a size of 3 to 100 nm are preferably used for preparation purpose, more preferably 5 to 70 nm.

An average particle size of the polymer emulsion of the present invention is preferably 10 to 300 nm, more preferably 50 to 200 nm in the points of surface glossiness of the coated product, ink-absorption property of the ink-receptive layer and a viscosity-increasing property at a low temperature. The average particle size herein mentioned means a number average particle size measured by the dynamic light scattering method at a temperature higher than the thermosensitive temperature.

Specific examples of such a polymer emulsion may include polymer emulsions disclosed in the above-mentioned International Patent Application WO 02/85634 and Japanese Provisional Patent Publication No. 2003-40916, and they are preferably used in the present invention.

When the polymer emulsion of the present invention is added to a coating solution, the time of addition may be at any time so long as it is before coating. It is preferably added to the coating solution at a temperature not lower than the thermosensitive temperature. The coating solution is preferably maintained at a temperature not lower than the thermosensitive temperature until it is applied to coating.

When the coating solution is applied to a substrate, it is immediately cooled to a temperature not higher than the thermosensitive temperature of the polymer emulsion, preferably a temperature 5° C. or more lower than the thermosensitive temperature, more preferably cooled to a temperature 5° C. or more lower than the thermosensitive temperature and not higher than 10° C. for 10 seconds or longer, and then, dried at a temperature of 60° C. or lower. By using these drying conditions, an ink-jet recording material excellent in glossiness and ink-absorption property can be produced with high productivity.

That is, by using a polyvinyl alcohol as a main component of a binder, and using a thermosensitive polymer emulsion in combination, the coated solution strongly thickens when it is cooled to a temperature not higher than the thermosensitive temperature of the thermosensitive polymer emulsion and a void structure can be maintained when it is dried at a relatively potent drying conditions. Thus, it is possible to produce an ink-jet recording material having high glossiness and ink-absorption property with high productivity.

A content of the polymer emulsion of the present invention to be contained in the ink-receptive layer is in the range of 1 to 25% by weight, preferably in the range of 5 to 20% by weight based on the amount of the polyvinyl alcohol in terms of a solid content. By using the polymer emulsion in the above-mentioned range, sufficient viscosity-increasing property can be obtained when the coating solution is made low temperature, and good surface glossiness and ink-absorption property can be obtained. When an amount of the thermosensitive polymer emulsion is increased and the same amount or so of the thermosensitive polymer emulsion to that of the polyvinyl alcohol is used, surface glossiness tends to be lowered. By using the polymer emulsion in the above-mentioned range, viscosity-change of the coated solution is reversible. When the thickened coated solution by cooling is heated again, it shows flowability again, so that there is no problem in the production process such as clogging of the solution in a piping which causes at the time when the thermosensitive polymer emulsion is used as a main component of the binder.

It is preferred to add a cationic compound to the ink-receptive layer of the present invention for the purpose of improving water-resistance or the like. Examples of the cationic compound may include the cationic polymer and the water-soluble metallic compound mentioned in the above explanation of dispersing the silica. A cationic polymer having a molecular weight (Mw) of about 5,000 to about 100,000, and a compound comprising aluminum or a metal belonging to Group 4A (for example, zirconium, titanium, etc.) of the Periodic Table are preferred, and an aluminum compound is particularly preferably contained. The cationic compound may be a single kind of the compound or may be used a plural number of compounds in combination.

A coated amount after drying of the ink-receptive layer of the present invention is preferably in the range of 8 to 40 g/m², particularly preferably 10 to 30 g/m² in terms of a solid component of the inorganic fine particles in the points of ink-absorption property, strength of the ink-receptive layer and productivity.

In the ink-jet recording material of the present invention, in addition to at least one of the above-mentioned ink-receptive layer containing the above-mentioned thermosensitive polymer emulsion, an ink-absorption layer with the other constitution or a layer having other function such as a protective layer may be further provided.

When two or more ink-receptive layers are provided in a laminated structure on the support, it is preferred to add the polymer emulsion in an ink-receptive layer provided nearer to the support and not to add the polymer emulsion in an ink-receptive layer provided further from the support.

In the present invention, to the ink-receptive layer, various kinds of conventionally known additives such as a coloring dye, a coloring pigment, a fixing agent of an ink dye, an UV absorber, an antioxidant, a dispersant of the pigment, an antifoaming agent, a leveling agent, an antiseptic agent, a fluorescent brightener, a viscosity stabilizer, a pH buffer, etc. may be added.

When the surfactant is used, those which can make a surface tension of the coating solution for preparing the ink-receptive layer 25 mN/m or less, and a fluorine type surfactant is preferably used.

In the present invention, the coating method of the respective layers is not particularly limited and a conventionally known coating method may be used. For example, there may be mentioned a slide bead system, a curtain system, an extrusion system, an air knife system, a roll coating system, a rod bar coating system, etc.

As a support to be used in the present invention, there may be mentioned, for example, a water-resistant support such as a film of a polyethylene, polypropylene, polyvinyl chloride, a diacetate resin, a triacetate resin, cellophane, an acryl resin, polyethylene terephthalate, polyethylene naphthalate, etc., and a polyolefin resin-coated paper, etc., a water-absorptive paper such as uncoated paper, art paper, coated paper, cast-coated paper, and the like. Of these, a water-resistant support is preferably used, and a polyolefin resin-coated paper is particularly preferably used. A thickness of the support is preferably about 50 μm to about 250 μm.

When a coating solution for preparing an ink-receptive layer is provided on a film support or a resin-coated paper support, it is preferred to carry out a corona discharge treatment, flame treatment, UV ray irradiation treatment, plasma treatment and the like prior to provision of the coating.

When a support, particularly a film or a resin-coated paper which is a water-resistant support is used, a primer layer mainly comprising a natural polymer compound or a synthetic resin is preferably provided on the surface of the support on which the ink-receptive layer is to be provided. When the ink-receptive layer containing silica fine particles of the present invention is provided on the primer layer and then it is dried at a relatively lower temperature, transparency of the ink-receptive layer is more improved.

The primer layer to be provided on the support mainly comprises a natural polymer compound such as gelatin, casein, etc., or a synthetic resin. The synthetic resin may include an acryl resin, a polyester resin, a polyvinylidene chloride resin, a polyvinyl chloride resin, a polyvinyl acetate resin, a polystyrene, a polyamide resin, a polyurethane resin, etc.

The above-mentioned primer layer is provided on the support with a thickness (dried thickness) of preferably 0.01 to 5 μm, more preferably in the range of 0.05 to 5 μm.

To the support of the present invention, various kinds of back coating layer(s) may be provided for the purpose of providing writability, antistatic property, conveying property, anticurl property, etc. In the back coating layer, an inorganic antistatic agent, an organic antistatic agent, a hydrophilic binder, a latex, an anticuring agent, a pigment, a curing agent, a surfactant, etc. may be included in optional combination.

### EXAMPLES

In the following, the present invention is explained in more detail by referring to Examples, but the present invention is not limited by these Examples. Incidentally, all “part(s)” and “%” mean “part(s) by weight” and “% by weight” of a solid component.

### Example 1

<Preparation of Paper Support Coated with Polyolefin Resin>

A mixture of a bleached kraft pulp of hardwood (LBKP) and a bleached sulfite pulp of softwood (NBSP) with a weight ratio of 1:1 was subjected to beating until it becomes 300 ml by the Canadian Standard Freeness to prepare a pulp slurry. To the slurry were added alkyl ketene dimer in an amount of 0.5% by weight based on the amount of the pulp as a sizing agent, polyacrylamide in an amount of 1.0% by weight based on the same as a strengthening additive of paper, cationic starch in an amount of 2.0% by weight based on the same, and polyamide epichlorohydrin resin in an amount of 0.5% by weight based on the same, and the mixture was diluted by water to prepare a 1% by weight slurry. This slurry was made paper by a tourdrinier paper machine to have a basis weight of 170 g/m², dried and subjected to moisture conditioning to prepare a base paper for a polyolefin resin-coated paper. A polyethylene resin composition comprising 100% by weight of a low density polyethylene having a density of 0.918 g/cm³ and 10% by weight of anatase type titanium oxide dispersed uniformly in the resin was melted at 320° C. and the melted resin composition was subjected to extrusion coating on a surface on which the ink-receptive layer is provided of the above-mentioned base paper with a thickness of 35 μm by 200 m/min and subjected to extrusion coating by using a cooling roll subjected to slightly roughening treatment. On the other surface of the base paper, a blended resin composition comprising 70 parts by weight of a high density polyethylene resin having a density of 0.962 g/cm³ and 30 parts by weight of a low density polyethylene resin having a density of 0.918 g/cm³ was melted similarly at 320° C. and the melted resin composition was subjected to extrusion coating with a thickness of 30 μm and subjected to extrusion coating by using a cooling roll subjected to roughening treatment.

Onto the front surface of the above-mentioned polyolefin resin-coated paper was subjected to a high frequency corona discharge treatment, and then, a coating solution for forming a subbing layer was coated thereon to have a gelatin amount of 50 mg/m² and dried to prepare a support.

<Subbing layer>

| | |
|---|---|
| Lime-treated gelatin | 100 parts |
| 2-Ethylhexyl sulfosuccinate | 2 parts |
| Chromium alum | 10 parts |

<Thermosensitive Polymer Emulsion>

A polymer emulsion having a core portion (a number average particle diameter: 11 nm) which comprises 5 parts of N,N-dimethylaminopropyl acrylamide methyl chloride quaternary salt, 9 parts of methyl methacrylate, 9 parts of butyl acrylate, 9 parts of styrene, 2 parts of diacetone acrylamide and 2 parts of 2-hydroxyethyl methacrylate, and a shell portion which comprises 290 parts of N-isopropyl acrylamide, 10 parts of diacetone acrylamide and 3.5 parts of N,N-dimethylaminopropyl acrylamide methyl chloride quaternary salt, with a number average particle size of 100 nm, a resin solid component of 11% and an ethanol content of 20% with the remainder being water was prepared. The thermosensitive temperature of the polymer emulsion was 30° C.

<Silica Dispersion 1>

To water were added a dimethyldiallyl ammonium chloride homopolymer (molecular weight (Mw): 9,000, 4 parts) and precipitated silica (oil absorption amount: 200 ml/100 g, average primary particle size: 16 nm, average secondary particle size: 9 μm, 100 parts), and the mixture was dispersed by using a saw blade type dispersing device (blade rim speed: 30 m/sec) to prepare a provisional dispersion. Next, the obtained provisional dispersion was treated by a beads mill to obtain Silica dispersion 1 with a solid concentration of 30% by weight and an average secondary particle size of 200 nm.

<Silica Dispersion 2>

To water were added a Dimethyldiallyl ammonium chloride homopolymer (molecular weight (Mw): 9,000, 4 parts) and fumed silica (average primary particle size: 7 nm, specific surface area: 300 m²/g, 100 parts), and the mixture was dispersed to prepare a provisional dispersion. Then, the obtained provisional dispersion was treated by a high pressure homogenizer to obtain Silica dispersion 2 with a solid concentration of 20% by weight and an average secondary particle size of 140 nm.

<Recording Sheet 1>

The above-mentioned Silica dispersion 1 and other chemicals were mixed at 50° C. to prepare Coating solution 1 for ink-receptive layer with the following composition. The coating solution was applied onto the above-mentioned support so that a coated amount of the silica particles was 20 g/m² by a slide bead coating system. Then, the coated material was firstly cooled at 8° C. for 30 seconds, and then an air with a temperature of 20 to 45° C. was successively blown to carry out drying.

<Coating solution 1 for ink-receptive layer>

| | |
|---|---|
| Silica dispersion 1 (as silica solid content) | 100 parts |
| Polyvinyl alcohol | 18 parts |
| (Saponification degree: 88%, average | |
| polymerization degree: 3,500) | |
| Boric acid | 3 parts |
| Solid concentration of silica | 16% by weight |

<Recording Sheet 2>

Cooling and drying conditions of the above-mentioned Recording sheet 1 were changed. First, the material was cooled at 8° C. for 15 seconds, and then an air with a temperature of 35 to 55° C. was successively blown to carry out drying.

<Recording Sheet 3>

Recording sheet 3 was prepared in the same manner as in Recording sheet 2 except for changing the binder component of the above-mentioned Coating solution 1 for ink-receptive layer from 18 parts of polyvinyl alcohol to 15 parts of polyvinyl alcohol and 3 parts of the thermosensitive polymer emulsion (20% by weight based on the amount of the polyvinyl alcohol in terms of a solid content).

<Recording Sheet 4>

Recording sheet 4 was prepared in the same manner as in Recording sheet 2 except for changing the binder component of the above-mentioned Coating solution 1 for ink-receptive layer from 18 parts of polyvinyl alcohol to 13 parts of polyvinyl alcohol and 5 parts of the thermosensitive polymer emulsion (38% by weight based on the amount of the polyvinyl alcohol in terms of a solid content).

<Recording Sheet 5>

Recording sheet 5 was prepared in the same manner as in Recording sheet 2 except for changing the binder component of the above-mentioned Coating solution 1 for ink-receptive layer from 18 parts of polyvinyl alcohol to 18 parts of the thermosensitive polymer emulsion and removing boric acid.

<Recording Sheet 6>

The above-mentioned Silica dispersion 2 and other chemicals were mixed at 50° C. to prepare Coating solution 2 for ink-receptive layer with the following composition. The coating solution was applied onto the above-mentioned support so that a coated amount of the silica particles was 20 g/m² by a slide bead coating system. Then, the coated material was firstly cooled at 8° C. for 15 seconds, and then an air with a temperature of 35 to 55° C. was successively blown to carry out drying.

<Coating solution 2 for ink-receptive layer>

| | |
|---|---|
| Silica dispersion 2 (as silica solid content) | 100 parts |
| Polyvinyl alcohol | 23 parts |
| (Saponification degree: 88%, average | |
| polymerization degree: 3,500) | |
| Boric acid | 4 parts |
| Basic polyaluminum hydroxide | 3 parts |
| (Pyurakemu WT, trade name, available | |
| from Riken Green K.K.) | |
| Solid concentration of silica | 10% by weight |

<Recording Sheet 7>

Recording sheet 7 was prepared in the same manner as in Recording sheet 6 except for changing the binder component of the above-mentioned Coating solution 2 for ink-receptive layer from 23 parts of polyvinyl alcohol to 20 parts of polyvinyl alcohol and 3 parts of the thermosensitive polymer emulsion (15% by weight based on the amount of the polyvinyl alcohol in terms of a solid content).

<Recording Sheet 8>

Recording sheet 8 was prepared in the same manner as in Recording sheet 6 except for changing the binder component of the above-mentioned Coating solution 2 for ink-receptive layer from 23 parts of polyvinyl alcohol to 17 parts of polyvinyl alcohol and 6 parts of the thermosensitive polymer emulsion (35% by weight based on the amount of the polyvinyl alcohol in terms of a solid content).

<Recording Sheet 9>

Recording sheet 9 was prepared in the same manner as in Recording sheet 6 except for changing the binder component of the above-mentioned Coating solution 2 for ink-receptive layer from 23 parts of polyvinyl alcohol to 23 parts of the thermosensitive polymer emulsion and removing boric acid.

With regard to the respective ink-jet recording sheets thus obtained, the following evaluation was carried out. The results are shown in Table 1.

<Evaluation of Coating Defect>

A coated surface of the coated and dried ink-receptive layer was observed with naked eyes and evaluated by the following criteria.

◯: No coating defect and the coated surface was uniform.

Δ: Pale coating strips occurred partially.

X: Coating strips occurred on the whole surface.

<Glossiness at White Portion>

Glossiness at the white paper portion of the recording material before printing was observed with inclined light and evaluated by the following criteria.

◯: It possesses high glossy feeling as that of a color photography.

Δ: There is a little glossy feeling.

X: There is no glossy feeling.

<Ink-absorption Property>

By using a commercially available ink-jet printer (PM-950C, trade name, available from Seiko Epson K.K., Japan), solid printing with red, blue, green or black color was each carried out, and immediately after the printing, a PPC paper was overlapped over the printed portion with a slight pressurization, and the degree of an amount of the ink transferred to the PPC paper was observed with naked eyes and evaluated by the following criteria.

○: No transfer was observed.

◯: Slight transfer was observed.

Δ: Pale transfer was observed at the whole part of the printed portion.

X: Dark transfer was observed at the whole part of the printed portion.

Also, with regard to the respective coating solutions, the following evaluation was carried out.

<Reversibility of Coating Solution after Gellation>

The respective coating solutions were each placed in a beaker, and gelled by cooling to 10° C. Then, the gelled material was heated to 40° C. and the state of the coating solution was observed. Reversibility of the coating solution was evaluated by the following criteria.

◯: There is a flowability.

X: There is no flowability.

TABLE 1

| Record- | | White | | Ink- | |
|---|---|---|---|---|---|
| ing | Coating | portion | absorption | Gelation | |
| sheet | defects | glossiness | property | reversibility | Remarks |
| 1 | Δ | ◯ | ◯ | ◯ | Comparative |
| 2 | X | Δ | Δ | ◯ | Comparative |
| 3 | ◯ | ◯ | ⊚ | ◯ | This invention |
| 4 | ◯ | X | ⊚ | ◯ | Comparative |
| 5 | ◯ | ◯ | ⊚ | X | Comparative |
| 6 | Δ | Δ | Δ | ◯ | Comparative |
| 7 | ◯ | ◯ | ⊚ | ◯ | This invention |
| 8 | ◯ | X | ⊚ | ◯ | Comparative |
| 9 | ◯ | ◯ | ⊚ | X | Comparative |

From the results as mentioned above, it can be understood that ink-jet recording material having good ink-absorption property and showing little coating defects even when drying conditions had been made severe to heighten productivity can be obtained by using a thermosensitive polymer emulsion in an ink-jet recording material having a porous ink-receptive layer which contains inorganic fine particles and polyvinyl alcohol. In the present invention, no irreversible gellation occurs as in the case where the thermosensitive polymer emulsion was used as a main component of the binder. Also, when an amount of the thermosensitive polymer emulsion is too much, glossiness is lowered, so that it can be understood that the amount of the thermosensitive polymer emulsion is set to be in the range of the present invention based on the amount of the polyvinyl alcohol.

According to the present invention, an ink-jet recording material having photo-like high glossiness, excellent in ink absorption property, and having high productivity can be obtained.

1. An ink-jet recording material comprising a support, and at least one porous ink-receptive layer containing inorganic fine particles and polyvinyl alcohol provided as a main component of a binder on the support, wherein at least one of said ink-receptive layers contains a polymer emulsion containing a polymer compound which shows a hydrophilic property at a temperature region of a predetermined temperature, which is a thermosensitive temperature, or less and shows a hydrophobic property at a temperature region higher than the thermosensitive temperature in an amount of 1 to 25% by weight based on the amount of the polyvinyl alcohol in terms of a solid content.

2. The ink-jet recording material according to claim 1, wherein the inorganic fine particles are fine particles in which wet process silica is pulverized to have an average secondary particle size of 400 nm or less.

3. The ink-jet recording material according to claim 1, wherein the inorganic fine particles are fumed silica.

4. The ink-jet recording material according to claim 1, wherein the polymer emulsion is contained in an amount of 5 to 20% by weight based on the amount of the polyvinyl alcohol in terms of a solid content.

5. The ink-jet recording material according to claim 1, wherein the polymer emulsion has a thermosensitive temperature in the range of 5 to 50° C.

6. The ink-jet recording material according to claim 5, wherein the polymer emulsion has a thermosensitive temperature in the range of 5 to 40° C.

7. The ink-jet recording material according to claim 1, wherein the polymer emulsion has an average particle diameter in the range of 10 to 300 nm.

8. The ink-jet recording material according to claim 7, wherein the polymer emulsion has an average particle diameter in the range of 50 to 200 nm.

9. The ink-jet recording material according to claim 1, wherein a crosslinking agent of the polyvinyl alcohol is further contained in the ink-receptive layer.

10. The ink-jet recording material according to claim 9, wherein the crosslinking agent is boric acid, borax or a borate.

11. The ink-jet recording material according to claim 1, wherein the support is a water-resistant support.

12. The ink-jet recording material according to claim 11, wherein the water-resistant support is a polyolefin resin-coated paper.

13. The ink-jet recording material according to claim 1, wherein the polymer emulsion comprises an N-alkyl or N-alkylene (meth)acrylamide compound.

14. The ink-jet recording material according to claim 13, wherein the polymer emulsion comprises a homopolymer or copolymer of at least one monomer selected from the group consisting of N-ethyl(meth)acrylamide, N-isopropyl(meth)acrylamide, N-cyclopropyl(meth)acrylamide, N-ethyl(meth)acrylamide, N,N-diethylacrylamide, N,N-dimethyl(meth)acrylamide, N-n-propyl(meth)acrylamide, N-methyl-N-n-propylacrylamide, N-methyl-N-isopropylacrylamide, N-(meth)acryloylpyrrolidine, N-(meth)acryloylpiperidine, N-tetrahydrofurfuryl(meth)acrylamide, N-methoxypropyl(meth)acrylamide, N-ethoxypropyl(meth)acrylamide, N-isopropoxypropyl(meth)acrylamide, N-ethoxyethyl(meth)acrylamide, N-(2,2-dimethoxyethyl)-N-methylacrylamide, N-methoxyethyl(meth)acrylamide and N-(meth)acryloylmorpholine.

15. The ink-jet recording material according to claim 13, wherein the polymer emulsion comprises a homopolymer or copolymer of at least one monomer selected from the group consisting of N-isopropylacrylamide, N-n-propylacrylamide, N,N-diethylacrylamide and N-acryloylmorpholine.
